(19) United States
(12) Patent Application Publication
(10) Pub. No.: US 2013/0344925 A1
(43) Pub. Date: Dec. 26, 2013

(54) PHONE CASE WITH KEY SLOT

(71) Applicants: David S. Lu, Houston, TX (US); Jonathan Hsieh, Potomac, MD (US)

(72) Inventors: David S. Lu, Houston, TX (US); Jonathan Hsieh, Potomac, MD (US)

(21) Appl. No.: 13/925,677

(22) Filed: Jun. 24, 2013

Related U.S. Application Data
(60) Provisional application No. 61/663,163, filed on Jun. 22, 2012.

(51) Int. Cl. H04B 1/38

(52) U.S. Cl. CPC H04B 1/3888
USPC 455/575.8

(57) ABSTRACT

A cell phone case that includes an integrated key holder is provided. The cell phone case can include a first portion that covers the sides and back of an upper portion of a cell phone body and a second portion for covering the sides and back of a lower portion of the cell phone body. The first portion and the second portion can be capable of being engaged with each other to form the cell phone case. The first portion and/or the second portion can include on a back panel, a side facing away from a screen of the cell phone, a cutout sized to removably hold a key.

### CROSS-REFERENCE TO RELATED APPLICATIONS

This application claims the benefit of U.S. Provisional Patent Application No. 61/663,163, filed Jun. 22, 2012, which is incorporated herein by reference in its entirety.

### FIELD OF THE INVENTION

The present disclosure relates to a cell phone case with a key slot.

### BACKGROUND OF THE INVENTION

As cell phones become more prevalent, they are increasingly being carried by individuals that do not carry wallets or purses, for example, children, teenagers, etc. These individuals typically carry their cells phones in their pants pockets, backpacks, or in their hand. They may also, however, need to carry a key to access their homes. Carrying a cell phone and a key in the same pocket can result in scratches to the cell phone screen or other damage. Further, the small size of keys makes them easy to lose. Thus, there is a need to solve these and other problems with the prior art.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1A is a front view of a cell phone in a case according to present embodiments.

FIG. 1B is a back view of a cell phone in a case according to present embodiments.

FIG. 1C is a back view of a cell phone in another case according to present embodiments.

FIG. 2A is a front view a cell phone in a case according to present embodiments.

FIG. 2B is a back view a cell phone in case according to present embodiments.

### DESCRIPTION OF THE EMBODIMENTS

Reference will now be made in detail to the present embodiment(s) (exemplary embodiments) of the invention, an example(s) of which is (are) illustrated in the accompanying drawings.

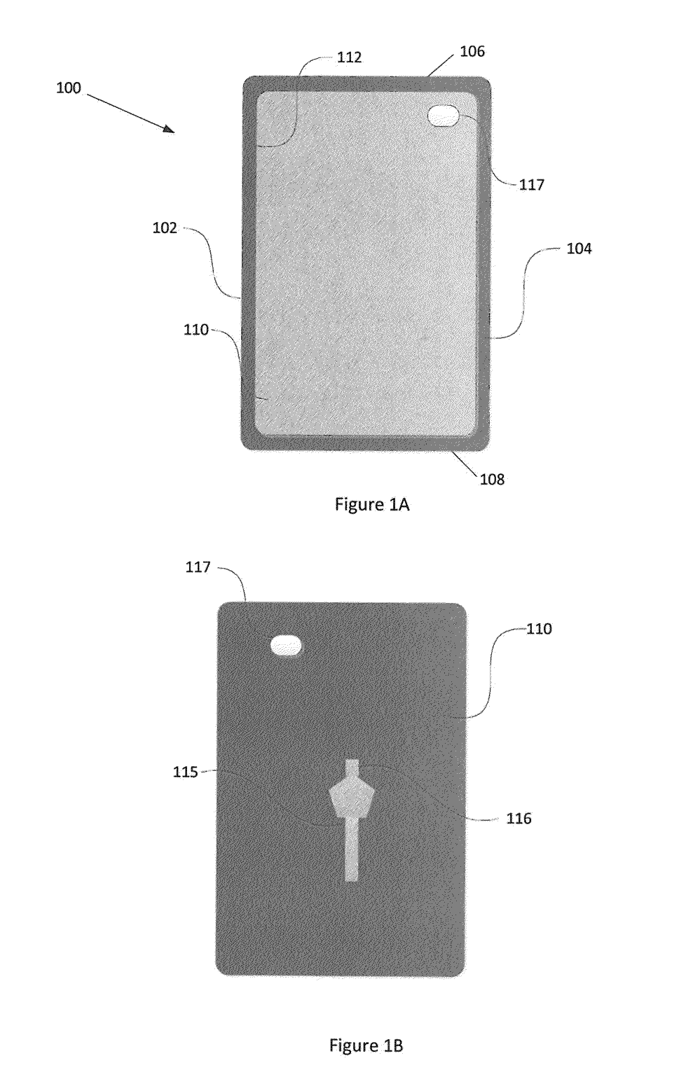

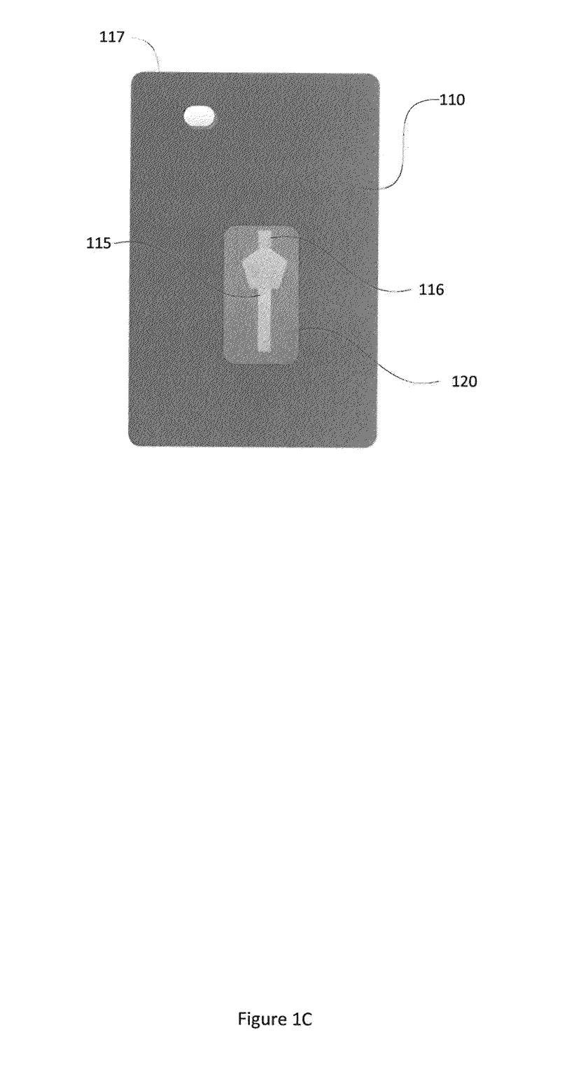

FIG. 1A shows a front view of a cell phone case 100 including side portions 102 and 104, a top portion 106, a bottom portion 108, and a back portion 110 according to present embodiments. When a cell phone is placed into case 100, the back portion 110 is adjacent to a back of a cell phone, the back of the cell phone being a side opposite a front side of the cell phone wherein the front side includes a screen. The case 100 can be a single piece being flexible enough to allow insertion and removal of the cell phone from the case. In further embodiments, one or more of side portions 102 and 104, top portion 106 and bottom portion 108 can include a lip 112 that extends over a portion of the front of the cell phone to hold it cell phone more securely. The case 100 can also include a cutout 117, for example, to allow use of a cellphone camera. Other cutouts can provide access to a headphone jack, power and volume buttons, etc. of the cell phone. In various embodiments, the case can be made of any cell phone case material including but not limited to plastic, rubber, leather, metal, and various combinations thereof.

FIG. 1B shows a back view of cell phone case 100 according to present embodiments. As shown in FIG. 1B, the back of the case can include a cutout 11 for holding a key. The shape of the cutout 115 can approximate the shape of a key and allow it to hold variously shaped keys. In various embodiments, cell phone case 100 is formed of a plastic material with sufficient elasticity to hold a key in place. In other embodiments, where cell phone case 100 is formed of a material without sufficient elasticity to hold variously shaped keys, e.g., metal, leather, and some plastics, back portion 110 can include a key portion 120 formed of a material with sufficient elasticity of hold variously shaped keys as shown in FIG. 1C. Key portion 120 can be disposed on back portion 110 or disposed within back portion 110. A position of cutout 115 can vary with respect to back of cell phone case 100. The cutout 115 can further include a slot 116 to facilitate removal of the key. A position of slot 116 can vary with respect to cutout 115. The cutout 115 can extend partially though the thickness of the back of the case 110 in order to prevent the key from contacting and potentially damaging the back of the cell phone. In other embodiments, the cutout 115 can extend fully through the thickness of the back of the case 110. The thickness of back portion 110 of the case should be sufficient to allow the key to be securely held. For example, the thickness of the back of the case can be thicker, thinner, or the same thickness as a thickness of the key to be held. In other embodiments, the thickness of the back of the case can vary, for example, being thicker in the vicinity of the cutout to accommodate the thickness of the key and thinner near the edges of the case.

In various other embodiments, the back of the case can include a strap or other feature that extends over a portion of the cutout to hold the key in place. For example, a strap can extend over the cutout so that a key can be inserted underneath. In this manner, the strap prevents the key from falling out of the cutout.

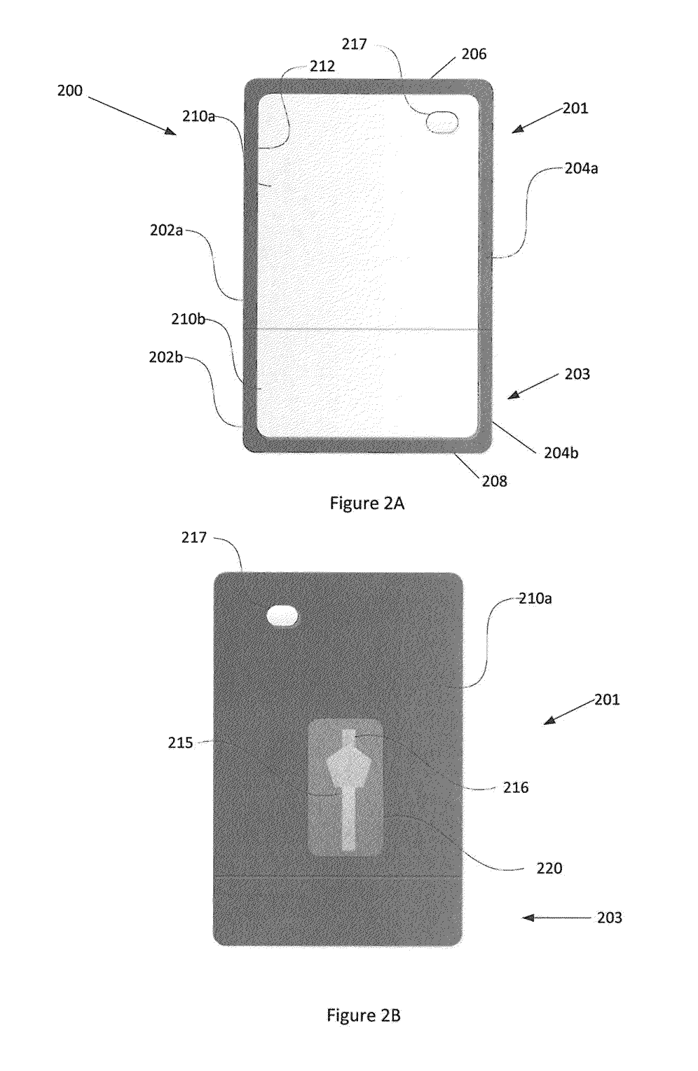

In further embodiments, as shown in FIG. 2, a cell phone case 200 can include two or more pieces such that the cell phone can be inserted into the case by sliding the cell phone into the two or more pieces. A first piece 201 can slidably connect with a second piece 203 to form case 200 that includes side portions 202 and 204, a top portion 206, a bottom portion 208, and a back portion 210. The case 200 can also include a cutout 215, for example, to allow use of a cellphone camera. Other cutouts can provide access to a headphone jack, power and volume buttons, etc. of the cell phone. In various embodiments, the case can be made of any cell phone case material including but not limited to plastic, rubber, leather, metal, and various combinations thereof.

Cell phone case 200 can be formed of two or more pieces such that a first piece 201 that can fit over an upper portion of a cell phone body. The first piece 201 can include a back portion 210a (that covers the side of the cell phone opposite the screen), side portions 202a and 204a, and a top portion 206. The first piece 201 can be installed on the cell phone by sliding the first portion 201 over the top of the cell phone.

The cell phone case can include a second piece 203 for covering a lower portion of the cell phone. The second piece 203 can include a back portion 210b, side portions 202b, 204b, and a bottom portion 208. The second piece 203 can be installed on the cell phone by sliding the second piece 203 over the bottom of the cell phone. In various embodiments, the first piece 201 and the second piece 203 can be capable of being engaged with each other to form the cell phone case.

FIG. 2B shows a back view of cell phone case 200 according to present embodiments. As shown in FIG. 2B, the back portion 210a of the case can include a cutout 215 for holding a key. The shape of the cutout 215 can approximate the shape of a key and allow it to hold variously shaped keys. In various embodiments, cell phone case 200 is formed of a plastic material with sufficient elasticity to hold a key in place. In other embodiments, where cell phone case 200 is formed of a material without sufficient elasticity to hold variously shaped keys, e.g., metal, leather, and some plastics, back portion 210a can include a key portion 220 formed of a material with sufficient elasticity of hold variously shaped keys. Key portion 215 can be disposed on back portion 210a or 210b, or be disposed within back portion 210a or 210b. A position of cutout 215 can vary with respect to back of cell phone case 200. The cutout 215 can further include a slot 216 to facilitate removal of the key. A position of slot 216 can vary with respect to cutout 215. The cutout 215 can extend partially though the thickness of the back of the case 210a or 201b in order to prevent the key from contacting and potentially damaging the back of the cell phone. In other embodiments, the cutout 215 can extend fully through the thickness of the back of the case 210a or 210b. The thickness of back portion 210a and 210b of the case should be sufficient to allow the key to be securely held. For example, the thickness of the back of the case can be thicker, thinner, or the same thickness as a thickness of the key to be held. In other embodiments, the thickness of the back of the case can vary, for example, being thicker in the vicinity of the cutout to accommodate the thickness of the key and thinner near the edges of the case. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cell phone case comprising:
a first portion for covering an upper portion of a cell phone body, the first portion comprising a back panel; and
a second portion for covering a lower portion of the cell phone body, the first portion and the second portion capable of being engaged with each other to form the cell phone case,
wherein the back panel of the first portion comprises, on a side facing away from a screen of the cell phone, a cutout sized to removably hold a key.

2. The cell phone case of claim 1, further comprising a strap disclosed over a portion of the cutout to keep the key in place.

3. The cell phone case of claim 1, wherein the first portion and the second portion are formed of rubber, plastic, leather, metal, and combinations thereof.

4. A cell phone case comprising:
a unitary body comprising,
a back panel,
a top panel,
and side panels,
wherein the back panel comprises, a cutout sized to re lovably hold a key.

5. The cell phone case of claim 4, further comprising a strap disclosed over a portion of the cutout to keep the key in place.

6. The cell phone case of claim 4, wherein the first portion and the second portion are formed of rubber, plastic, leather, metal, and combinations thereof.

7. A cell phone case comprising:
a first portion for covering an upper portion of a cell phone body, the first portion comprising a back panel and formed of a first material;
a second portion for covering a lower portion of the cell phone body, the first portion and the second portion capable of being engaged with each other to form the cell phone case; and
a third portion comprising a second material having a higher elasticity than the first material and disposed on or within the first portion, wherein the third portion comprises, on a side facing away from a screen of the cell phone, a cutout sized to removably hold a key.
